(19) United States
(12) Patent Application Publication
(10) Pub. No.: US 2015/0207674 A1
(43) Pub. Date: Jul. 23, 2015

(54) Control Method and Device for Protecting Connectivity between Ethernet Ring Network Nodes, and First Node

(71) Applicant: ZTE Corporation, Shenzhen (CN)

(72) Inventors: Shaoyong Wu, Shenzhen (CN); Jin Yang, Shenzhen (CN); Yuxi Gan, Shenzhen (CN)

(21) Appl. No.: 14/421,320

(22) PCT Filed: Jul. 10, 2013
(86) PCT No.: PCT/CN2013/079156

§ 371 Date: Feb. 12, 2015

(30) Foreign Application Priority Data
Sep. 18, 2012 (CN) 201210346466.8

(51) Int. Cl. H04L 12/24; H04L 12/703; H04L 12/721

(52) U.S. Cl. CPC H04L 41/0668; H04L 45/66; H04L 41/12; H04L 45/28

(57) ABSTRACT

A control method and apparatus for protecting connectivity between Ethernet ring network nodes, and a first node. The control method comprises: the first node supporting an Ethernet ring network protection technology interacting with the second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node; when the first node detects a link fault, blocking a port connecting the first node to a failure link end; the first node sending a link fault alarm protocol frame to other nodes supporting the Ethernet ring network protection technology, to perform protection switchover.

### TECHNICAL FIELD

The present invention relates to the Ethernet ring network technology, and in particular, to a control method and apparatus for protecting connectivity between Ethernet ring network nodes when there is an incompatible device in the Ethernet ring network and a first node.

### BACKGROUND OF THE RELATED ART

The Ethernet develops toward the direction of multi-service carrying, and with the higher requirements on the reliability and the instantaneity of the network, etc., by some services, the Ethernet already adopts the redundancy networking mode extensively to improve the reliability of the network, to meet the demand such as the instantaneity of the service, etc. In the redundancy networking structure of the Ethernet, it is usually required that the speed of the protection switching is fast enough and the duration of the protection switching needs to be within 50 ms.

At present, the technologies related to the fast protection switching are the RFC3619 standard provided by the Internet Engineering Task Force (IETF) and the G.8032 standard provided by the International Telecommunications Union (ITU-T), etc.

In the G.8032 standard provided by the ITU-T, the automatic protection switchover protocol and mechanism are defined for the Ethernet layer of the ring topology Ethernet, and such automatic protection switchover method is suitable for the ring topology Ethernet. The implementation procedure of the method is as follows: in the ring topology Ethernet, a section of link is selected as the ring protection link; when the links of the Ethernet ring network are all fault-free, there is at least one node which blocks the port connected with the ring protection link in the two adjacent nodes of the ring protection link, to prevent the protected data from passing through the ring protection link; in this way, there is only the unique communication path between any two nodes on the Ethernet ring network, so the closed loop in the communication path will not be generated in the Ethernet ring network, to prevent the closed loop and the network storm; when the link in the Ethernet ring network fails and the fault link is not the ring protection link, the node which originally blocks the port connected to the ring protection link opens the blocked port, to make the protected data be able to pass through the ring protection link, thus make the communication path be established again and the reliability of the network be improved.

FIG. 1 is a structure diagram of an Ethernet ring network based on the G.8032 standard. As shown in FIG. 1, the nodes S1, S2, S3 and S4 make up the Ethernet ring network, the link between the nodes S1 and S4 is the ring protection link, the node S1 is the node affiliated to the ring protection link, and the node S1 controls the blocking and opening of the port 11 to be able to block and open the ring protection link. When the links of the Ethernet ring network are all fault-free, the node S1 blocks the port 11, to prevent the protected data from passing through the ring protection link; at this moment the communication path of the flow rate of the protected data between the nodes S2 and S3 is only S2<->S3, while it cannot be S2<->S1<->S4<->S3. The Operation Administration and Maintenance (OAM) domain is set up among the adjacent nodes, to detect the connectivity of the link, and the basic principle of the OAM detection is that, two nodes of the region send the detection frame to the opposite end node mutually; and if the node does not receive the detection frame of the opposite end within a period of time, then the link fault is detected; if the node receives the detection frame of the opposite end again after detecting the link fault, then the link recovery is detected.

FIG. 2 is a structure diagram of an Ethernet ring network after the link fails in FIG. 1. As shown in FIG. 2, supposing that the link between the node S2 and the node S3 fails, then the node S2 and the node S3, after detecting the failure, block the port 22 and the port 31 connected with the failed link respectively, and send the link fault alarm protocol frame to notify other nodes supporting the Ethernet ring network protection technology to perform the protection switchover; after the node S1 affiliated to the ring protection link receives the link fault alarm protocol frame, the blocked port 11 connected to the ring protection link is opened, and each node on the Ethernet ring network refreshes the address forwarding table, to realize the network protection switchover, and the protected data can pass through the opened ring protection link. Now the communication path of the protected data between the node S2 and the node S3 is S2<->S1<->S4<->S3. Here, the link fault is one situation causing the protection switching, and in real application, it can also include the situations, such as, the manual switchover, the switchover by force, etc.

Though the technology, such as the Ethernet ring network of the G.8032 standard, etc., provides the automatic protection switchover protocol and mechanism, the launching time of the G.8032 is later than the application time of the Ethernet, so in the real network, the scene that the new device supporting the G.8032 and the old device not supporting the G.8032 make the networking together is very general; there are often nodes that do not support the G.8032 standard in the Ethernet ring network, which leads to that the butt joint among the nodes is incompatible and the automatic protection switchover of the Ethernet ring network cannot be realized.

The nodes S1, S2, S5, S6, S3 and S4 make up the Ethernet ring network in FIG. 3; except the nodes S5 and S6, other nodes support the Ethernet ring network protection technology of the G.8032 standard, the link between the nodes S1 and S4 is the ring protection link, the node S1 is the node affiliated to the ring protection link, and the node S1 controls the blocking and opening of the port 11 to be able to block and open the ring protection link. When the links of the Ethernet ring network are all fault-free, the node S1 blocks the port 11, to prevent the protected data from passing through the ring protection link. When the link between the node S5 and node S6 fails, because the nodes S5 and S6 do not support the Ethernet ring network protection technology of the G.8032 standard and will not send the link fault alarm protocol frame to other nodes, other nodes will not know the fault state, and the S1 affiliated to the ring protection link will not open the blocked port 11 connected with the ring protection link either, thus, two break-offs, the port 11 of the node S1 and the link S5<->S6, appear in the ring, which causes the flow rate of the protected data break off.

So in the real application of the network, the scene that the nodes supporting the Ethernet ring network protection technology and the nodes not supporting the Ethernet ring network protection technology make the networking together is more and more general; if there is no technology processing the butt joint to the incompatible Ethernet ring network node, the application of the network protection switchover technology will be obstructed greatly, and even the network failure is caused, so a technology processing the butt joint to the incompatible Ethernet ring network node is required, to ensure the maximum connectivity of the network.

### CONTENT OF THE INVENTION

The technical problem that the embodiment of the present invention requires to solve is to provide a technology for processing the butt joint incompatible with the Ethernet ring network protection technology, which can perform the protection switchover and ensure the maximum connectivity of the network when there is the node not supporting the Ethernet ring network protection technology in the Ethernet ring network.

In order to achieve the above-mentioned objective, the embodiment of the present invention provides a control method for protecting connectivity between Ethernet ring network nodes, used for a first node supporting an Ethernet ring network protection technology, comprising: interacting with a second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node; when detecting a link fault, blocking a port connecting the first node to a failure link end; and sending a link fault alarm protocol frame to other nodes supporting the Ethernet ring network protection technology in the Ethernet ring network, to notify other nodes supporting the Ethernet ring network protection technology to perform protection switchover.

Alternatively, in the above-mentioned control method, the link fault alarm protocol frame comprises a first node number of the first node; and the control method further comprises: after receiving the link fault alarm protocol frame sent by the second node when detecting the link fault, comparing a second node number of the second node carried in the received link fault alarm protocol frame with the first node number, judging whether a comparison result meets a preset condition, and if the comparison result meets the preset condition, then opening a port blocked by the first node supporting the Ethernet ring network protection technology and connected to the failure link end.

Alternatively, in the above-mentioned control method, the preset condition is that the second node number is greater than the first node number or the second node number is smaller than the first node number.

In order to achieve the above-mentioned objective, the embodiment of the present invention further provides a control apparatus for protecting connectivity between Ethernet ring network nodes, used for a first node supporting an Ethernet ring network protection technology, comprising: a link connectivity detection unit, configured to interact with a second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node; a port blocking unit, configured to: when detecting a link fault, block a port connecting the first node to a failure link end; and a link fault alarm protocol frame transceiving unit, configured for the first node supporting the Ethernet ring network protection technology to send a link fault alarm protocol frame to notify other nodes supporting the Ethernet ring network protection technology to perform protection switchover.

Alternatively, in the above-mentioned control apparatus, the link fault alarm protocol frame comprises a first node number of the first node; and the control apparatus further comprises: a comparison and judgment control unit, configured to: after receiving the link fault alarm protocol frame sent by the second node when detecting the link fault, compare a second node number of the second node carried in the received link fault alarm protocol frame with the first node number, judge whether a comparison result meets a preset condition, and if the comparison result meets the preset condition, then open a port blocked by the first node supporting the Ethernet ring network protection technology and connected to the failure link end.

Alternatively, in the above-mentioned control apparatus, the preset condition is that the second node number is greater than the first node number or the second node number is smaller than the first node number.

In order to achieve the above-mentioned objective, the embodiment of the present invention further provides a node device comprising the above-mentioned control apparatus for protecting the connectivity between the Ethernet ring network nodes.

By adopting the method and apparatus of the embodiment of the present invention, when the link connected to the node not supporting Ethernet ring network protection technology fails, nodes supporting the Ethernet ring network protection technology adjacent to the node not supporting Ethernet ring network protection technology can detect the link fault through the connectivity detection, to realize the network protection switchover; and the protected data can pass through the opened ring protection link, thus ensuring the connectivity of the service data. At the same time, after the two nodes supporting the Ethernet ring network protection technology and detecting the link fault receive the link fault alarm protocol frame from each other mutually, the node of which the node number is smaller (or uniquely greater than) opens the blocked port, and the node not supporting the Ethernet ring network protection technology transmits the service data through the opened port with other nodes. So the embodiment of the present invention can not only make the incompatible Ethernet ring network node be able to process the butt joint, but also ensures the maximum connectivity of the network.

### BRIEF DESCRIPTION OF DRAWINGS

FIG. 1 is a structure diagram of an Ethernet ring network based on a G.8032 standard;

FIG. 2 is a structure diagram of an Ethernet ring network after a link fails;

FIG. 3 is a structure diagram that there is a node not supporting an Ethernet ring network protection technology in the Ethernet ring network;

FIG. 4 is a flow chart of a control method for protecting connectivity between Ethernet ring network nodes according to an embodiment of the present invention;

FIG. 5 is a structure diagram of a control apparatus for protecting connectivity between Ethernet ring network nodes according to an embodiment of the present invention;

FIG. 6 is a structure diagram of an Ethernet ring network according to an embodiment of the present invention;

FIG. 7 is a processing diagram of a failure in an Ethernet ring network according to an embodiment of the present invention;

FIG. 8 is a processing diagram of ensuring the maximum connectivity of the network in an Ethernet ring network according to an embodiment of the present invention;

FIG. 9 is a structure diagram of an Ethernet ring network according to another embodiment of the present invention;

FIG. 10 is a processing diagram of a failure in an Ethernet ring network according to another embodiment of the present invention;

FIG. 11 is a processing diagram of ensuring the maximum connectivity of the network in an Ethernet ring network according to another embodiment of the present invention.

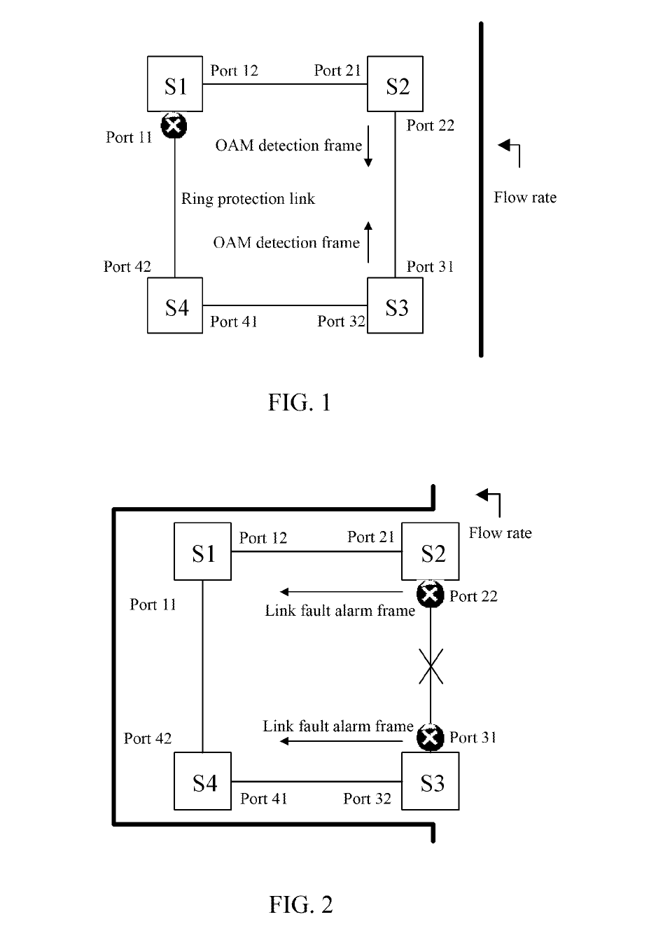

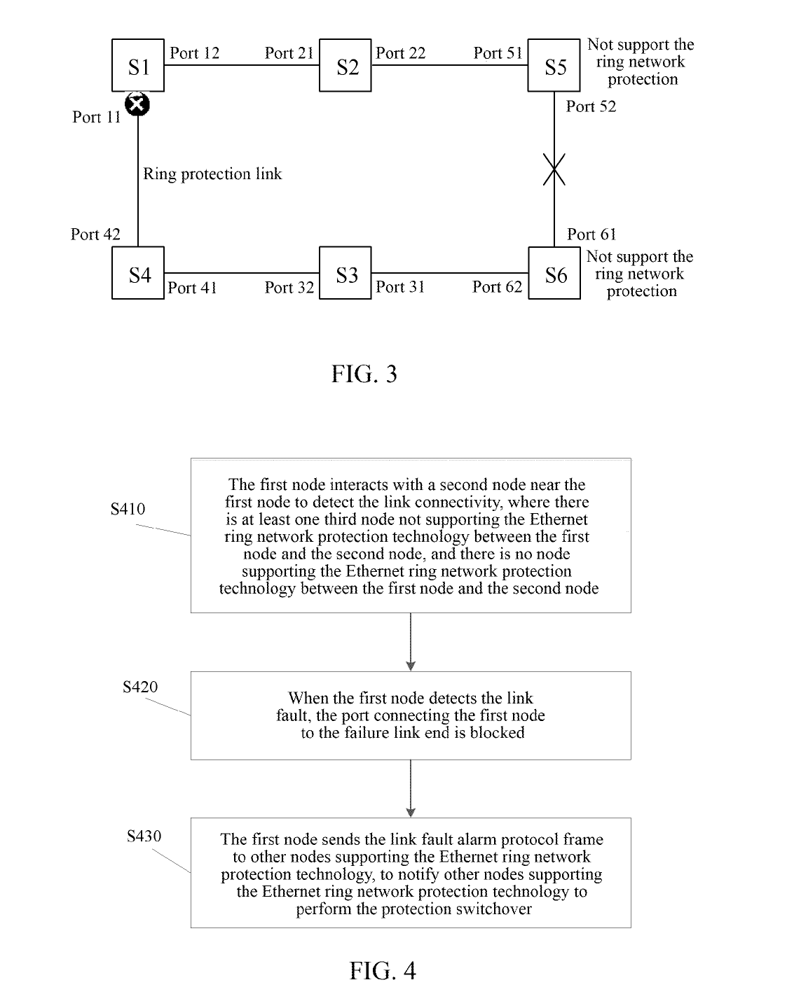

### PREFERRED EMBODIMENTS OF THE PRESENT INVENTION

The present invention is described in detail with reference to the accompanying drawings and the embodiments hereinafter.

### Embodiment One

The control method for protecting connectivity between Ethernet ring network nodes provided by the embodiment of the present invention is shown in FIG. 4 specifically, including the following steps.

In step S410, the first node supporting an Ethernet ring network protection technology interacts with a second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node.

In the Ethernet ring network, if two adjacent nodes support the Ethernet ring network protection technology, then the link connectivity is detected between these two adjacent nodes.

If the two adjacent nodes are not all supporting the Ethernet ring network protection technology, then between the two nodes supporting the Ethernet ring network protection technology adjacent to the node not supporting the Ethernet ring network protection technology, the link connectivity is detected through the mode of penetrating the node not supporting the Ethernet ring network protection technology.

In step S420, when the first node supporting the Ethernet ring network protection technology detects the link fault, the port connecting the first node to the failure link end is blocked.

In step S430, the first node supporting the Ethernet ring network protection technology sends the link fault alarm protocol frame to other nodes supporting the Ethernet ring network protection technology, to notify other nodes supporting the Ethernet ring network protection technology to perform the protection switchover.

In the step, the link fault alarm protocol frame sent by the first node supporting the Ethernet ring network protection technology to other nodes supporting the Ethernet ring network protection technology includes the node number of the first node.

The connection among most nodes can be realized through the above-mentioned mode. While in order to improve the connection rate, the specific embodiment of the present invention further includes the following step.

After receiving the link fault alarm protocol frame sent by the second node supporting the Ethernet ring network protection technology when the second node detects the link fault, the first node supporting the Ethernet ring network protection technology compares the second node number of the second node carried in the received link fault alarm protocol frame with the first node number, judges whether a comparison result meets a preset condition, and if the comparison result meets the preset condition, then opens the port blocked by the first node supporting the Ethernet ring network protection technology and connected to the failure link end.

The preset condition is that the received second node number sent by the second node supporting the Ethernet ring network protection technology is greater or smaller than the first node number of the first node supporting the Ethernet ring network protection technology.

Certainly, it should be understood that all nodes can use the same judgment criterion.

By adopting the method provided by the embodiment of the present invention, when the link connected to the node not supporting Ethernet ring network protection technology fails, the adjacent node supporting the Ethernet ring network protection technology node can detect the link fault through the connectivity detection, and then blocks the failure port, and sends the link fault alarm protocol frame to notify other nodes supporting the Ethernet ring network protection technology to perform the protection switchover; after the node affiliated to the ring protection link knows the link fault, the blocked port connected with the ring protection link is opened, and each node on the Ethernet ring network refreshes the address forwarding table, to realize the network protection switchover; and the protected data can pass through the opened ring protection link, to ensure the connectivity of the service data. But because both two nodes supporting the Ethernet ring network protection technology and detecting the link fault block the failure ports, the nodes not supporting the Ethernet ring network protection technology are unable to transmit the service data with other nodes, which cannot ensure the maximum connectivity of the network. After the two nodes supporting the Ethernet ring network protection technology and detecting the link fault receive the link fault alarm protocol frame from each other mutually, if it is found that its own node number is smaller (or uniquely greater than) the node number of the node of the other side, then the node opens the blocked port, and the node not supporting the Ethernet ring network protection technology transmits the service data through the opened port with other nodes. So the embodiment of the present invention can not only make the incompatible Ethernet ring network node be able to process the butt joint, but also ensures the maximum connectivity of the network.

### Embodiment Two

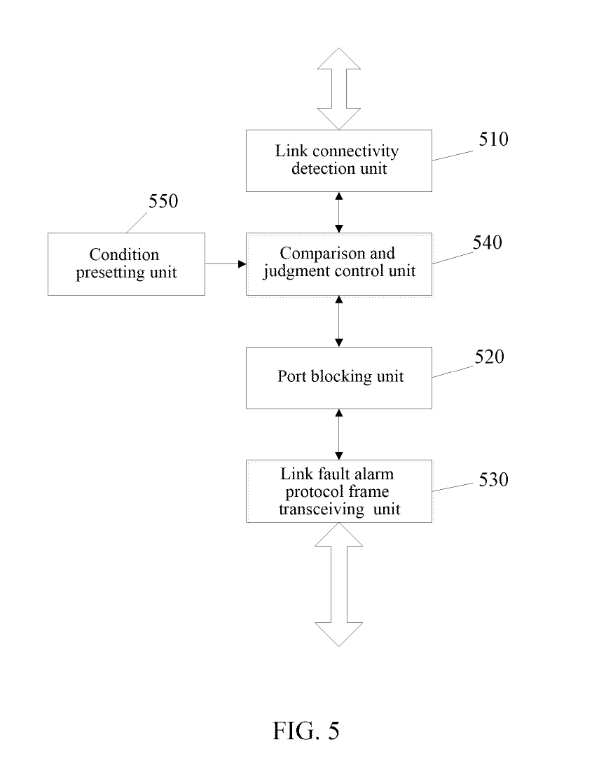

The control apparatus for protecting the connectivity between the Ethernet ring network nodes provided by the embodiment of the present invention is used for the first node, and its specific structure is as shown in FIG. 5, and the apparatus includes the following units.

The link connectivity detection unit 510 is configured to detect the link connectivity between the first node supporting the Ethernet ring network protection technology and the second node supporting the Ethernet ring network protection technology and near the first node, wherein, there is at least one third node not supporting the Ethernet ring network protection technology between the first node and the second node, and there is no node supporting the Ethernet ring network protection technology between the first node and the second node.

The port blocking unit 520 is configured to: when the link connectivity detection unit detects that the link fault occurs between the two adjacent first node and second node supporting the Ethernet ring network protection technology, block the port connecting the first node to the failure link end.

The link fault alarm protocol frame transceiving unit 530 is configured for the first node supporting the Ethernet ring network protection technology to send the link fault alarm protocol frame to notify other nodes supporting the Ethernet ring network protection technology to perform the protection switchover.

The link fault alarm protocol frame transceiving unit 530 includes the node number of the first node in the link fault alarm protocol frame sent to other nodes supporting the Ethernet ring network protection technology.

The control apparatus provided by the embodiment of the present invention further includes the following units.

The comparison and judgment control unit 540 is configured to: after the first node supporting the Ethernet ring network protection technology receives the link fault alarm protocol frame sent by the second node supporting the Ethernet ring network protection technology when detecting the link fault, compare the second node number of the second node carried in the detected link fault alarm protocol frame with its own first node number, judge whether the comparison result meets a preset condition, and if the comparison result meets the preset condition, then open the port blocked by the first node supporting the Ethernet ring network protection technology and connected to the failure link end.

The condition presetting unit 550 is configured to preset the condition, and the preset condition is that the received second node number sent by the second node supporting the Ethernet ring network protection technology is greater or smaller than the first node number of the first node supporting the Ethernet ring network protection technology.

The embodiment of the present invention provides the control apparatus for protecting the connectivity between the Ethernet ring network nodes, when the link connected to the node not supporting Ethernet ring network protection technology fails, the node supporting the Ethernet ring network protection technology node adjacent to the node not supporting Ethernet ring network protection technology can detect the link fault through the connectivity detection, to realize the network protection switchover; and the protected data can pass through the opened ring protection link, to ensure the connectivity of the service data.

### Embodiment Three

In order to describe the control method and apparatus for protecting the connectivity between the Ethernet ring network nodes provided by the embodiment of the present invention much more clear, another specific preferred embodiment is provided from the overall situation for explanation.

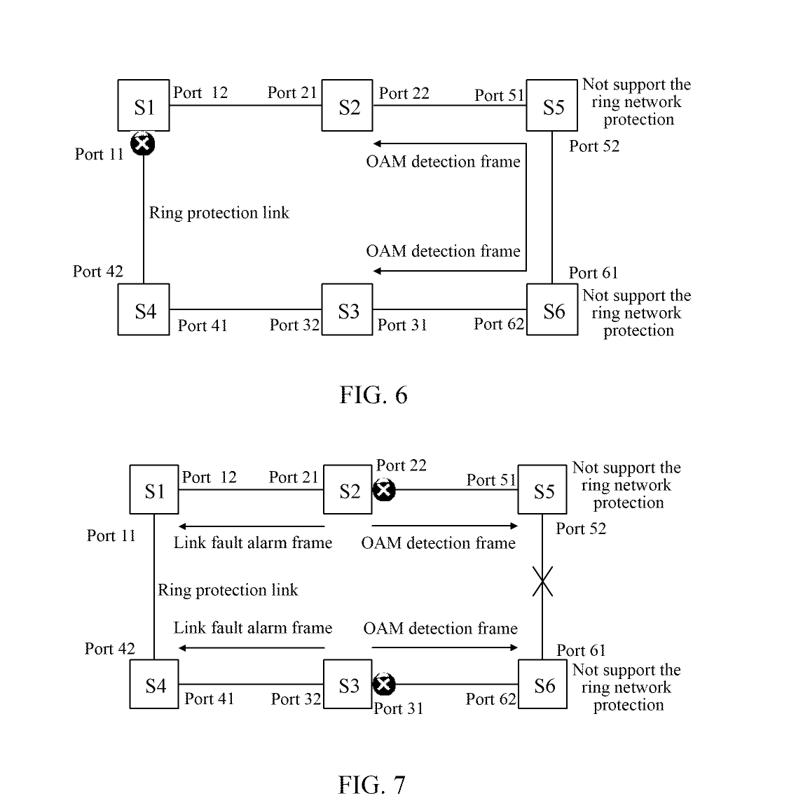

As shown in FIG. 6, the nodes S1, S2, S5, S6, S3 and S4 make up the Ethernet ring network in FIG. 6; except the nodes S5 and S6, other nodes support the Ethernet ring network protection technology of the G.8032 standard, the link between the nodes S1 and S4 is the ring protection link, the node S1 is the node affiliated to the ring protection link, and the node S1 controls the blocking and opening of the port 11 to be able to block and open the ring protection link. When the links of the Ethernet ring network are all fault-free, the node S1 blocks the port 11, to prevent the protected data from passing through the ring protection link.

Because the nodes S5 and S6 do not support the Ethernet ring network protection technology, the technology for detecting the link connectivity between the nodes S2 and S3 supporting the Ethernet ring network protection technology adjacent to the nodes S5 and S6 respectively is launched according to the technology of the embodiment of the present invention.

As shown in FIG. 7, in FIG. 7, when the link between the node S5 and the node S6 fails, the OAM detection frame between the nodes S2 and S3 cannot be connected, so the nodes S2 and S3 detect the link fault, and block the ports 22 and 31 connected to the failure link end respectively, and send the link fault alarm protocol frame to notify other nodes supporting the Ethernet ring network protection technology to perform the protection switchover, and their own node numbers are included in the link fault alarm protocol frame.

After the node S1 affiliated to the ring protection link receives the link fault alarm protocol frame, it opens the blocked port 11 connected with the ring protection link, and each node on the Ethernet ring network refreshes the address forwarding table, to realize the network protection switchover, and the protected data can pass through the opened ring protection link, so the node S2<->S1<->S4<->S3 can be connected therebetween, but because both the nodes S2 and S3 block the port connected with the failure link end, the nodes S5 and S6 cannot connect to other nodes.

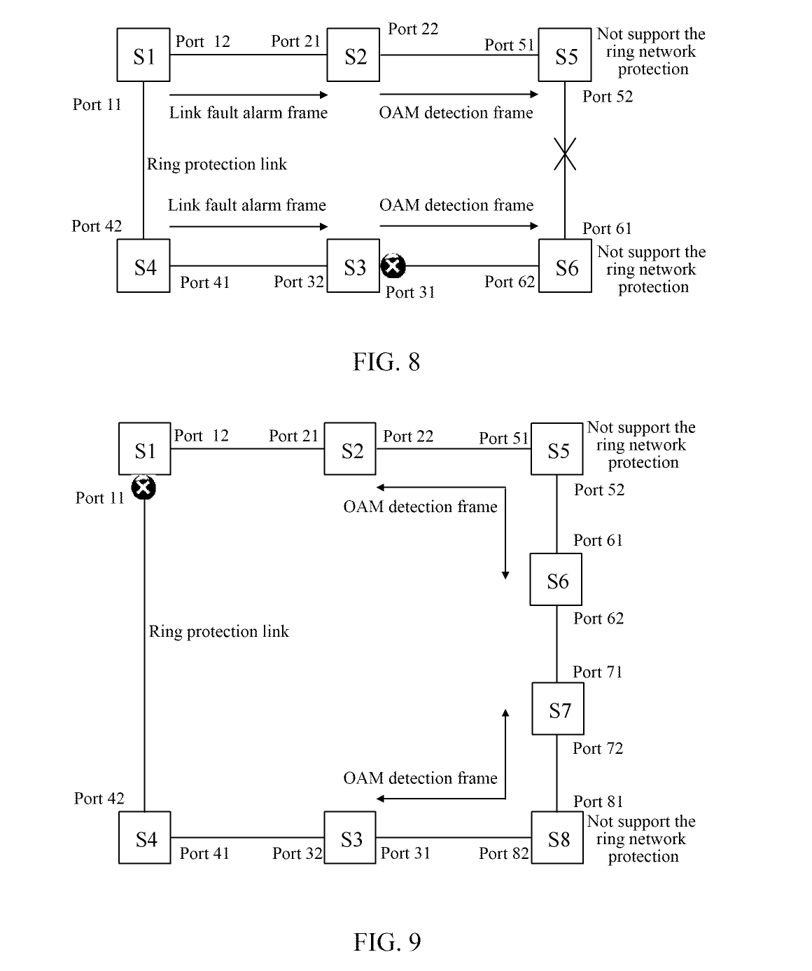

As shown in FIG. 8, after the node S3 receives the link fault alarm protocol frame of the node S2 in FIG. 8, because the node number (2) of the node S2 included in the protocol frame is smaller than the node number of the node S3 (supposing as 3), the node S3 keeps the port 31 as the blocked state according to the condition preset by the method of the embodiment of the present invention. After the node S2 receives the link fault alarm protocol frame of the node S3, because the node number of the node S3 (supposing as 3) included in the protocol frame is greater than the node number of the node S2 (supposing as 2), and the node S2 detects the link fault and the node S2 already blocks the port 22 connected with the failure link end, the node S2 opens the blocked port 22 connected with the failure link end according to the condition preset by the method of the embodiment of the present invention. After the port 22 of the node S2 is opened, the node S5 can be connected with other nodes, to ensure the maximum connectivity of the network.

### Embodiment Four

In order to describe the control method and apparatus for protecting the connectivity between the Ethernet ring network nodes provided by the embodiment of the present invention more clear, another specific preferred embodiment is provided from the overall situation for explanation.

FIG. 9-FIG. 11 are one more complex Ethernet ring network, wherein, the nodes S1, S2, S5, S6, S7, S8, S3 and S4 make up the Ethernet ring network; except the nodes S5 and S8, other nodes support the Ethernet ring network protection technology of the G.8032 standard, the link between the nodes S1 and S4 is the ring protection link, the node S1 is the node affiliated to the ring protection link, and the node S1 controls the blocking and opening of the port 11 to be able to block and open the ring protection link. When the links of the Ethernet ring network are all fault-free, the node S1 blocks the port 11, to prevent the protected data from passing through the ring protection link.

Because the nodes S5 and S8 do not support the Ethernet ring network protection technology, the technology for detecting the link connectivity is used between the nodes S2 and S6 supporting the Ethernet ring network protection technology adjacent to the nodes S5 according to the method of the embodiment of the present invention. The technology for detecting the link connectivity is used between the nodes S3 and S7 supporting the Ethernet ring network protection technology adjacent to the nodes S8.

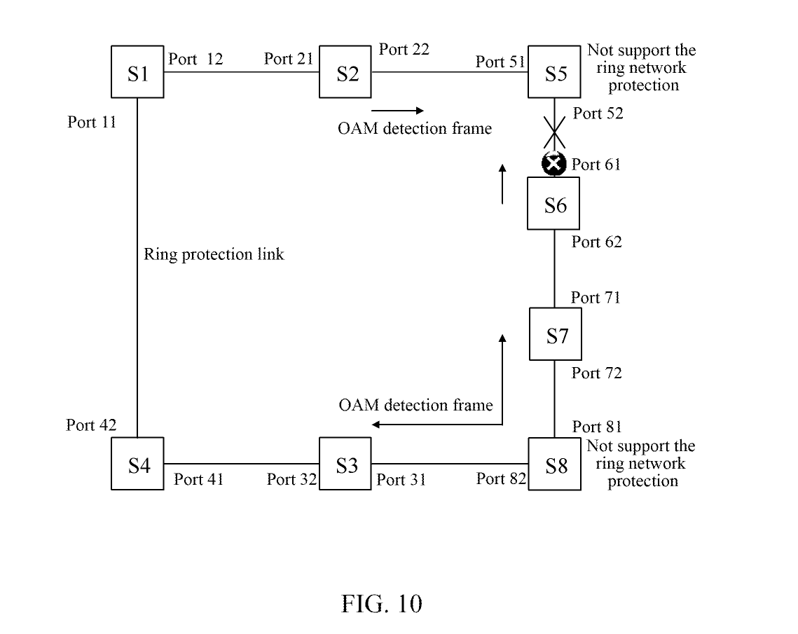

In FIG. 10, when the link between the node S5 and the node S6 fails, the OAM detection frame can not pass through between the nodes S2 and S6, so the nodes S2 and S6 detect the link fault, and block the ports 22 and 61 connected to the failure link end respectively, and send the link fault alarm protocol frame to notify other nodes supporting the Ethernet ring network protection technology to perform the protection switchover, and the node numbers of the node S2 and the node S6 are included in the link fault alarm protocol frame. After the node S1 affiliated to the ring protection link receives the link fault alarm protocol frame, it opens the blocked port 11 connected with the ring protection link, and each node on the Ethernet ring network refreshes the address forwarding table, to realize the network protection switchover, and the protected data can pass through the opened ring protection link. After the node S6 receives the link fault alarm protocol frame of the node S2, because the node number (2) of the node S2 included in the protocol frame is smaller than the node number of the node S6 (supposing as 6), the node S6 keeps the port 61 as the blocked state according to the condition preset by the method of the embodiment of the present invention. After the node S2 receives the link fault alarm protocol frame of the node S6, because the node number of the node S6 included in the protocol frame is greater than the node number of the node S2, and the node S2 detects the link fault and the node S2 already blocks the port 22 connected with the failure link end, the node S2 opens the blocked port 22 connected with the failure link end according to the condition preset by the method of the embodiment of the present invention. After the port 22 of the node S2 is opened, the node S5 can be connected with other nodes, to ensure the maximum connectivity of the network.

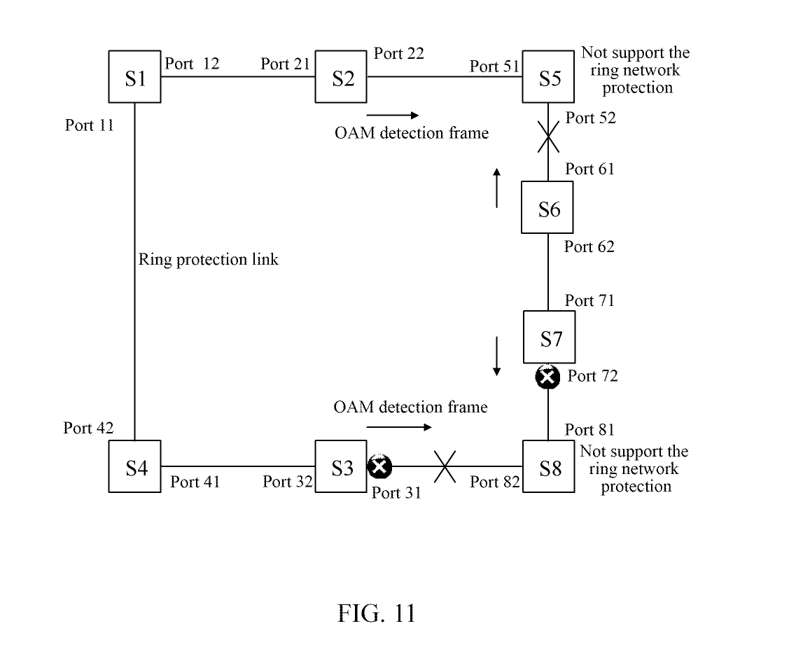

In FIG. 11, based on FIG. 10, when the link between the node S3 and the node S8 fails, the OAM detection frame can not pass through between the nodes S3 and S7, so the nodes S3 and S7 detect the link fault, and block the ports 31 and 72 connected to the failure link end respectively, and send the link fault alarm protocol frame to notify other nodes supporting the Ethernet ring network protection technology to perform the protection switchover, and include their own node numbers in the link fault alarm protocol frame. After the node S7 receives the link fault alarm protocol frame of the node S6, because the node number of the node S6 included in the protocol frame is smaller than the node number of the node S7, the node S7 keeps the port 72 as the blocked state according to the condition preset by the embodiment of the present invention. After the node S6 receives the link fault alarm protocol frame of the node S7, because the node number of the node S7 included in the protocol frame is greater than the node number of the node S6, and the node S6 detects the link fault and the node S6 already blocks the port 61 connected with the failure link end, the node S6 opens the blocked port 61 connected with the failure link end according to the condition preset by the embodiment of the present invention.

It can be understood by those skilled in the art that all or part of steps in the above-mentioned method can be fulfilled by programs instructing the relevant hardware components, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module/unit in the above-mentioned embodiments can be implemented in the form of hardware, or in the form of software function module. The present invention is not limit to any specific form of the combination of the hardware and software.

It should be explained finally that, the above-mentioned embodiments are only used to illustrate the technical scheme of the present invention while not to limit. Those skilled in the art should understand that they can make the modifications and equivalents according to the technical scheme of the present invention without departing from the spirit and scope of the present invention, which should be embodied in the scope of the appending claims of the present invention.

### INDUSTRIAL APPLICABILITY

By adopting the method and apparatus of the embodiment of the present invention, when the link connected to the node not supporting Ethernet ring network protection technology fails, the adjacent node supporting the Ethernet ring network protection technology node can detect the link fault through the connectivity detection, to realize the network protection switchover; and the protected data can pass through the opened ring protection link, to ensure the connectivity of the service data. At the same time, after the two nodes supporting the Ethernet ring network protection technology and detecting the link fault receive the link fault alarm protocol frame of the other side mutually, the node of which the node number is smaller (or uniquely greater than) opens the blocked port, and the node not supporting the Ethernet ring network protection technology transmits the service data through the opened port with other nodes. So the embodiment of the present invention not only can make the incompatible Ethernet ring network node be able to process the butt joint, but also ensures the maximum connectivity of the network.

1. A control method for protecting connectivity between Ethernet ring network nodes, used for a first node supporting an Ethernet ring network protection technology, comprising:
interacting with a second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node;
when detecting a link fault, blocking a port connecting the first node to a failure link end; and
sending a link fault alarm protocol frame to other nodes supporting the Ethernet ring network protection technology in the Ethernet ring network, to notify other nodes supporting the Ethernet ring network protection technology to perform protection switchover.

2. The control method according to claim 1, wherein, the link fault alarm protocol frame comprises a first node number of the first node; and the control method further comprises:
after receiving the link fault alarm protocol frame sent by the second node when detecting the link fault, comparing a second node number of the second node carried in the received link fault alarm protocol frame with the first node number, judging whether a comparison result meets a preset condition, and if the comparison result meets the preset condition, then opening a port blocked by the first node supporting the Ethernet ring network protection technology and connected to the failure link end.

3. The control method according to claim 2, wherein,
the preset condition is that the second node number is greater than the first node number or the second node number is smaller than the first node number.

4. A control apparatus for protecting connectivity between Ethernet ring network nodes, used for a first node supporting an Ethernet ring network protection technology, comprising:
a link connectivity detection unit, configured to interact with a second node supporting the Ethernet ring network protection technology and near the first node, to detect link connectivity, where there is at least one third node not supporting the Ethernet ring network protection technology between the first node and the second node, and there is no node supporting the Ethernet ring network protection technology between the first node and the second node;
a port blocking unit, configured to: when detecting a link fault, block a port connecting the first node to a failure link end; and
a link fault alarm protocol frame transceiving unit, configured to send a link fault alarm protocol frame to other nodes supporting the Ethernet ring network protection technology to notify other nodes supporting the Ethernet ring network protection technology to perform protection switchover.

5. The control apparatus according to claim 4, wherein, the link fault alarm protocol frame comprises a first node number of the first node; and the control apparatus further comprises:
a comparison and judgment control unit, configured to: after receiving the link fault alarm protocol frame sent by the second node when detecting the link fault, compare a second node number of the second node carried in the received link fault alarm protocol frame with the first node number, judge whether a comparison result meets a preset condition, and if the comparison result meets the preset condition, then open a port blocked by the first node supporting the Ethernet ring network protection technology and connected to the failure link end.

6. The control apparatus according to claim 5, further comprising: the preset condition is that the second node number is greater than the first node number or the second node number is smaller than the first node number.

7. A first node supporting an Ethernet ring network protection technology, comprising a control apparatus described in claim 4.
